(19) United States
(12) Patent Application Publication
(10) Pub. No.: US 2018/0196418 A1
(43) Pub. Date: Jul. 12, 2018

(54) METHOD FOR UNATTENDED OPERATIONS USING AUTONOMOUS OR REMOTELY OPERATED VEHICLES

(71) Applicant: XWORKS CORPORATION, Tulsa, OK (US)

(72) Inventors: Brian S. Meier, Sapulpa, OK (US); Tiziano FLORENZANI, Jenks, OK (US)

(21) Appl. No.: 15/747,319

(22) PCT Filed: Jul. 27, 2016
(86) PCT No.: PCT/US2016/044175

§ 371 Date: Jan. 24, 2018

Related U.S. Application Data
(60) Provisional application No. 62/197,401, filed on Jul. 27, 2015.
(60) Provisional application No. 62/359,464, filed on Jul. 7, 2016.

(51) Int. Cl. G05D 1/00; G05D 1/10; G05D 1/02; B64C 39/02; B65G 63/00

(52) U.S. Cl. CPC G05D 1/0011; G05D 1/101; G05D 1/0225; G05D 1/0206; B64C 39/024; B64D 9/00; B64C 2201/146; B64C 2201/141; B64C 2201/024; B64C 2201/206; B65G 63/002

(57) ABSTRACT

Remotely operated and autonomous vehicles can be coupled with a base station to perform at least one of refueling, loading cargo, and unloading cargo; without human intervention. By reducing the need for such intervention, the subject vehicles can be employed more economically and with reduced infrastructure.

### TECHNICAL FIELD

The present invention relates to unattended operations using vehicles. The present invention particularly relates to unattended operations using vehicles wherein the vehicles are autonomous or remotely operated.

### BACKGROUND

The use of autonomous or remotely operated vehicles is well known in the art. For example, remotely operated vehicles are commonly used undersea exploration, ordinance disposal, recreation. Autonomous vehicles such as aerial drones have been used for aerial mapping and gathering military intelligence. Self driving automobiles are being introduced by companies such as Google. Amazon.com has announced plans to provide aerial delivery of products using drones.

Automation fails in one of its essential purposes, namely freeing humans from repetitive and boring tasks, if the use of drones and autonomous vehicles requires too much human intervention. One example of such a failure is where human intervention is required for deploying and recovery of vehicles. Another example is where human intervention is required for the changing of payloads, batteries, and/or fuel supplies.

Existing landing aid systems, enabling autonomous craft to land, are currently based on various technologies such as instrument landing systems (ILS) or microwave landing systems (MLS), and their military equivalents, such as PAR-type radars. Such systems are unlikely to be deployed rapidly on a landing site because they require relatively large infrastructures to be put in place on the ground. They are therefore ill-suited to the use and recovery of drones.

Another means of guiding the landing of an aircraft consists in using GPS (or differential GPS) means-based systems which offer the advantage of being inexpensive to implement. However, this solution poses the problem of the availability or the continuity of GPS service in high-accuracy mode. Furthermore, the vulnerability of the GPS systems in the presence of scramblers is well known.

What these and even more sophisticated systems have in common is the inability of the systems to locate the vehicle to a position where it can be refueled, loaded, and unloaded. Conveyor systems have very small tolerances and it is important that fuel or battery ports line up and that conveyors marry up with a precision sufficient to allow such loading and unloading. It would be desirable in the art to provide a method and system for employing remotely operated and autonomously vehicles with a reduced need for human intervention in recovery, launching, loading, and unloading such vehicles,

### SUMMARY

In one aspect, the invention is a method for employing remotely operated and autonomous vehicles including guiding the vehicles into a position defined by x, y and z coordinates relative to a base station, wherein: the base station is configured to perform at least one function selected from the group consisting of refueling, recharging, change of instruments or payload, loading cargo, and unloading cargo; and the at least one function is performed without local human intervention.

In another aspect, the invention is a system for employing remotely operated and autonomous vehicles including: a base station, an apparatus used to guide the vehicles into a position defined by x, y and z coordinates relative to the base station, wherein: the base station is configured to perform at least one function selected from the group consisting of refueling, sheltering, storing, maintenance servicing, loading cargo, and unloading cargo; and the base station is configured to perform the at least one function without local human intervention.

In still another aspect, the invention is a system for employing remotely operated and autonomous vehicles including: a base station, an apparatus used to guide the vehicles into a position defined by x, y and z coordinates relative to the base station, wherein: the base station is configured to perform at least one function selected from the group consisting of refueling, sheltering, storing, maintenance servicing, loading cargo, and unloading cargo; and the base station is configured to perform at least one function without local human intervention wherein the base station is mobile and is a fixed wing aircraft, a rotor aircraft, a lighter than air aircraft, or an autonomous land or water vehicle.

In another aspect, the invention is a system for employing remotely operated and autonomous vehicles including: a base station, an apparatus used to guide the vehicles into a position defined by x, y and z coordinates relative to the base station, wherein: the base station is configured to perform at least one function selected from the group consisting of refueling, sheltering, storing, maintenance servicing, loading cargo, and unloading cargo; and the base station is configured to perform the at least one function without local human intervention wherein the base station is mobile and is an aircraft that employs a device to shift the center of gravity.

In yet another aspect, the invention is method for employing airborne remotely operated and autonomous vehicles including guiding the vehicles into a position defined by x, y and z coordinates relative to a base station, wherein: the base station is configured to perform at least one function selected from the group consisting of refueling, recharging, change of instruments or payload, loading cargo, and unloading cargo; and the at least one function is performed without local human intervention, and at least one part of the base station is configured to move in at least one x-y-z dimension to facilitate the landing of the airborne remotely operated and autonomous vehicles.

Another aspect of the invention is a system for delivery of materials utilizing an airborne remotely operated or autonomous vehicle including a cargo hub, a base station, a cargo and supply conveyance system and at least one airborne remotely operated or autonomous vehicle wherein the base station is deployed outside of the cargo hub to receive the remotely operated or autonomous airborne vehicle, the cargo and supply conveyance system is configured to load and unload cargo to and from the remotely operated or autonomous vehicle.

### BRIEF DESCRIPTION OF THE DRAWINGS

FIG. 1A is an illustration of a drone approaching a base station of the invention.

FIG. 1B is an illustration of the drone coupling with a docking probe which was extended from the base station.

FIG. 1C is an illustration of the drone landed on the base station with the drone still coupled to the docking probe which has been withdrawn back into the base station.

FIG. 2A is an illustration of the docking probe from a base station about to make contact with the coupling device of a drone.

FIG. 2B is an illustration of a slightly different embodiment showing a modified coupling device already intact with a docking probe.

FIG. 2C is an illustration of a different embodiment showing different type of coupling device.

FIG. 3 is an illustration of an automobile just before docking with a station.

FIG. 4 is an illustration of a drone approaching to dock with a airborne mobile base station.

FIG. 5 is an illustration of a fixed wing aircraft configured to shift its center of gravity.

FIG. 6A is an illustration of base station having a section of the base station displaced along the z axis.

FIG. 6B is an illustration of base station having a section of the base station displaced along the z axis and x axis.

FIG. 7A is an illustration of a cargo hub showing to base stations deployed thereon.

FIG. 7B is a cutaway view illustration of the cargo hub shown in FIG. 7A wherein one of the base stations has been lowered within the cargo hub.

It will be appreciated that the various Figures are not necessarily to scale and that certain features have been exaggerated for clarity and do not necessarily limit the features of the invention.

### DETAILED DESCRIPTION

In one embodiment, the invention is a method for employing remotely operated and autonomous vehicles including guiding the vehicles into a position defined by x, y and z coordinates relative to a base station, wherein: the base station is configured to perform at least one function selected from the group consisting of refueling, recharging, sheltering, storing, maintenance servicing, change of instruments or payload, loading cargo, and unloading cargo; and that at least one function is performed without local human intervention. For the purposes of this application, the terms “remotely operated vehicles” and “autonomous vehicles” means model aircraft, aircraft, terrestrial vehicles such as automobiles and tracked vehicles, and watercraft (both submersible and surface) that are capable of being operated remotely or which are capable of being tasked prior to being launched and able to perform that task and usually navigate themselves to a position to be recovered.

The term “performed without human intervention” means that the function was performed without the need for a local human being to initiate or facilitate the process being performed. This allows for, or rather the scope of this term includes both automatic operations and remotely initiated operations. For example, upon returning to a base station of the system of the application, a drone may be subject to automatic refueling. Also within the scope of this term would be a situation where a remote operator would conclude that there was insufficient fuel for the next mission and would send a signal to the base station to refuel the drone.

For the purposes of this application, the terms “fuel” and “refuel” include both the introduction of a combustible fuel, and the recharging or replacement of a battery or fuel cell.

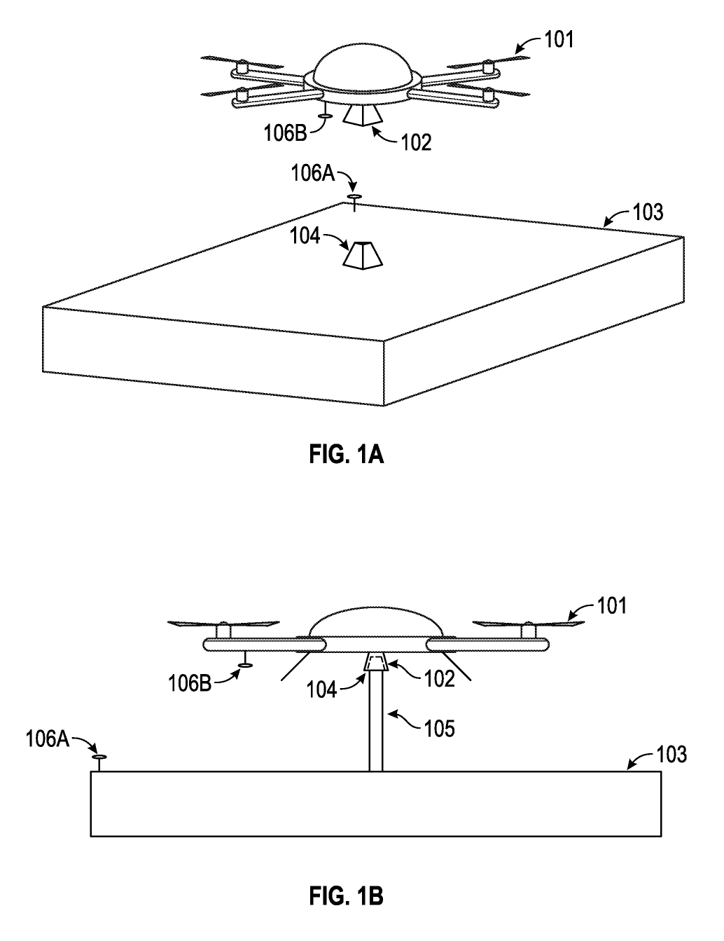

Turning to FIG. 1A, shown therein is an illustration of a drone (101) approaching a base station (103) of the invention. Also shown in this figure is a coupling device on the drone (102), and docking probe in the retracted position (104), and communication devices (106 A &B).

Turning to FIG. 1B, shown therein is a drone after coupling with a docking probe. The shaft (105) of the docking probe is shown in the extended position.

Turning to FIG. 1C, a drone is shown after landing on the base station. Note that the docking probe has been retracted but is still in contact with the coupling apparatus of the drone.

A problem solved by the method and system of the application is the precise guidance and location of the vehicle overcoming the inherent errors in location caused when navigating by GPS (Global Positioning System), cellular signals, and the like. Also resolved are problems associated with aging of equipment and the resulting misalignments that occur due thereto. Also resolved are the problems associated with aerodynamic forces caused by unpredictable air currents.

In one embodiment, the system of the application is directed primarily to aerial vehicles, especially those that are capable of vertical landings and take offs. The system shown in FIGS. 1A-C illustrates this embodiment. For example, a drone, navigating by a pre-programmed GPS location, approaches the base station. Once within range, in some embodiments, the drone communicates via a communication device directly with the base station and in alternative embodiments, the drone will communicate with a controller (not shown) to initiate a landing sequence during which the docking probe is extended.

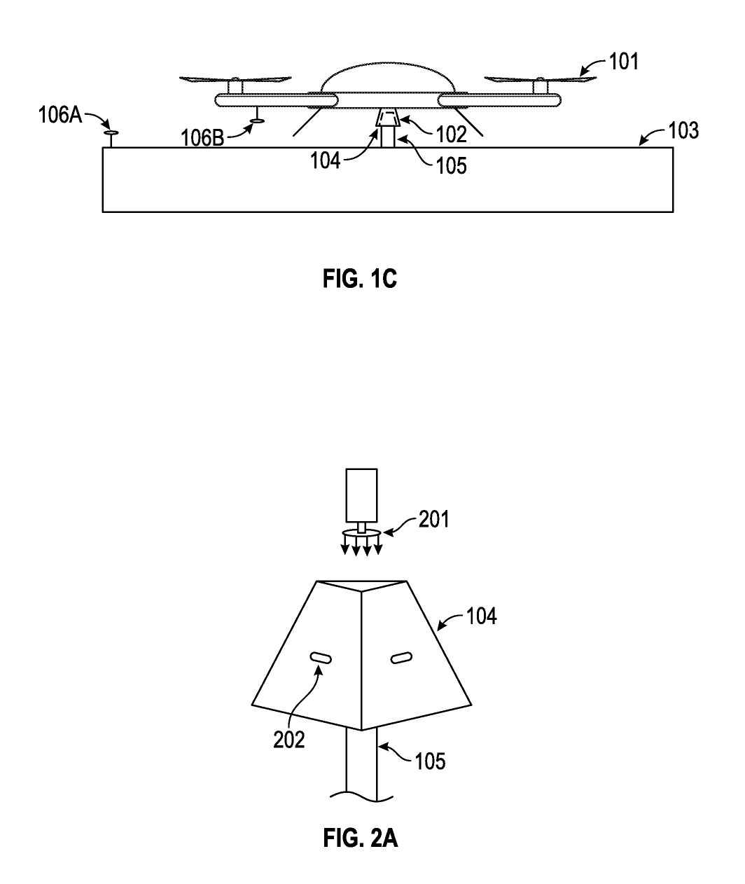

Turning to FIG. 2A, a first embodiment of the application is shown wherein the coupling apparatus incorporates a magnet (201). In some embodiment, the magnet is a rare earth magnet. For the purposes of this application, rare earth magnets, such as but not limited to samarian and neodymium based magnets, are ferrimagnetic and ferrimagnetic materials and may be used to prepare the Ferromagnetic or ferrimagnetic magnets useful with the application. Any magnetic material or material that is attracted to magnets may be used to prepare the magnets useful with the application. As can be appreciated, the stronger the magnet, the more easily the coupling device and docking probe can be docked.

In this embodiment, the magnet which is a part of the coupling apparatus, is attracted towards and guides the drone to the end of the docking probe. The directional pull of the magnet on the docking probe and, in some embodiments, a sensor within the landing apparatus (not shown), is used to assist the drone in landing on the base station with a greater accuracy than is possible using GPS or cellular data alone.

In a first alternative embodiment, the docking probe may also have a magnet. This would, in effect, increase the magnetic attraction between the docking probe and coupling apparatus.

Turning now to FIG. 2B, an embodiment wherein there is a magnet and a triangular shaped docking probe and complimentary shape to the coupling apparatus is shown. In this embodiment, the additional data regarding the heading orientation relative to the landing base can be acquired and used to rotate the so that is facing in the correct direction as it settles to the surface of the base station. Upon landing, the pyramidal apparatus and probe will be aligned so that they fit together. (See, FIG. 2C).

In FIG. 2, and elsewhere, the docking apparatus and docking probe were both pyramidal in shape. In an alternative embodiment they may be configured with a different geometry. For example in one embodiment, they may be in the shape of cones. In another embodiment, they may be in the shape of hemispheres. Any configuration known to those of ordinary skill in the art to be useful may be used with the method and systems of the application.

In still another alternative embodiment, neither the docking probe nor the coupling device has a magnet but rather one or the other will have a light source and the other will have a sensor capable of discriminating against ambient sources of light. In FIG. 2A, reference number (202) is used to show such a light source. For example, in one desirable embodiment, the three sides of the docking probe will have an RGB diode array or the like. In alternative embodiments, there may be 2 or even 1. One or more sensors in the pyramidal part of the coupling apparatus, using a charge coupled device (CCD) array and lens or the like, can then be used to determine exact proximity and orientation to the base station.

In an alternative embodiment, the sensors and sources may be inverted. In some embodiments, the sensors utilize infrared beacons. In others, a reflector may be employed.

Video cameras can also be employed as sensors as described immediately above. They can also be used to supplement other sensors. Data from video cameras, and any sensor capable of determining proximity such as radar, lasers, and the like; can be used with the method and systems of the application. In one embodiment of the application, more than one type of sensor is employed in the data from each is integrated to produce additional precision in locating an approaching vehicle, and in guiding that vehicle to the desired x, y and z coordinates. These additional sensors can be placed on the base station, the vehicle, or both.

Similar embodiments can be used with submersible water craft where a precise location for surfacing is needed. For example, for remote operated research craft which may need to surface into an underwater entrance on a research vessel, a substantially similar system may be employed with the exception that the vessel would be rising up rather settling down into position on the base station.

In marked contrast, the systems of the application may be used with water surface craft and terrestrial vehicles, but with less emphasis on the vertical axis. While the vertical axis is deemphasized, it cannot be ignored altogether as otherwise identical vehicles may age causing a weakening of suspensions or even suffer from under inflation of tires causing a misalignment along the vertical axis which could interfere with devices for loading or offloading cargo and the loading of fuel. This is especially true in regard to fueling where the fuel is a combustible liquid such as gasoline or a combustible gas such as propane.

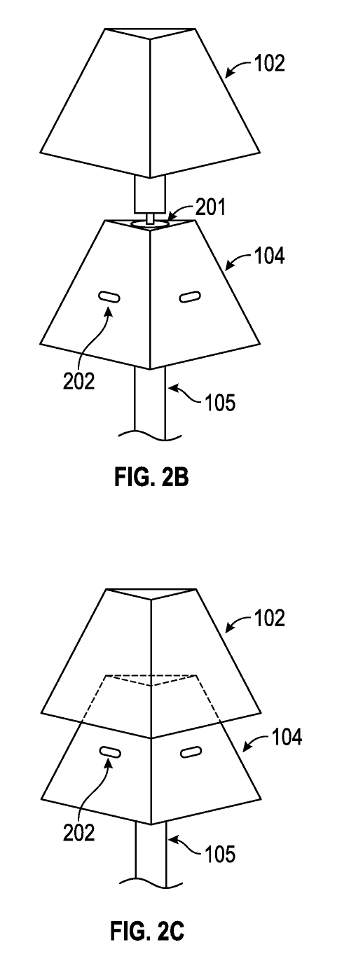

Turning now to FIG. 3, shown is an illustration of an automobile just before docking with a station. The base station has a designation of (300). Therein, an automobile (305) is shown approaching the docking probe (303) of the base station. The coupling apparatus (302) and the docking probe interact to determine the 3 dimensional position of the automobile and the information is used to steer the automobile into place. Additionally, the base station can raise and lower the automobile using a lift (305) designed for that purpose. By precisely locating the automobile into the docking station, automated systems to load fuel or unload cargo can marry together without the need for human intervention.

The same system may be used for tracked vehicles such as those used for ordinance disposal and aerial vehicles that do not have the ability to undertake vertical take offs and landings. For example, a remotely piloted fixed wing plane could land and then taxi up to a base station of the system of the application. The base station could then maneuver the fixed wing plane into position to be serviced by the base station.

In some embodiments, the systems of the application are used for refueling, loading cargo, and unloading cargo. In addition, the systems may perform other operations and have other features. One such operation would be simple maintenance. Exemplary such items include but are not limited to simple maintenance such as sensor and camera cleaning, cleaning cargo compartments, and the like.

The systems of the invention are particularly useful for end-use applications where low costs are advantageous. Such end-use applications include, but are not limited to: delivery of parcels by aerial drones, delivery of parcels by fixed wing and terrestrial drones and remotely operated vehicles, search and rescue, mapping, law enforcement, and the like.

The systems of the invention are also useful in such end-use applications such as the interchange of payloads or parcels between vehicles. For example, an aerial drone may deliver a parcel to a base station and another aerial drone or ground drone may pick up the same payload or parcel from the base station to deliver it on to yet another base station in a chain or to the end user. The end use is wide availability of rapid delivery.

By allowing small systems to operate with little human intervention, small systems can be put in place at remote locations to allow for quick response times. Small systems would also lend themselves to applications wherein the lack of infrastructure is a problem. For example, a small system could be put into place and powered by solar or wind power. Communications could be performed by satellite, ether conventionally or via GPS piggybacking.

In one especially desirable application, a system of the application could be incorporated into a base station located in a public location which would receive and hold small parcels. An autonomous aerial drone could drop off the parcel at a base station. The base station would secure the parcel and then release it to a recipient upon being provided with some form of electronic identification. This would be particularly useful for consumers who do not have access to an open space to accept delivery from such a vehicle.

Another embodiment of a system of the application is one where the base station, rather than being static and on the ground, is mobile. In one such embodiment, the mobile base station is a comparatively large (as compared to the autonomous vehicle carrying the parcel) fixed wing or other type of aircraft. It is well known in the art of aviation that fixed wing aircraft require dramatically less fuel/energy than rotary wing aircraft. Obviously, it is much easier to keep an aircraft airborne if the aircraft's forward motion is moving air across a wing large enough to do sufficient lift as compared to rotating propellers to maintain lift such as occurs with helicopters and other rotor type aircraft. If the mobile base stations is a lighter than air aircraft, energy savings and stability advantages could be realized in some applications.

One requirement for an airborne base station is that it have a sufficiently slow flight speed to allow docking with another autonomous aircraft. While fixed wing aircraft with stall speeds less than 10 kn are known, desirably the fixed wing aircraft used with the systems of the application will have a stall speed in excess of 10 kn. In some embodiments the stall speed of the airborne mobile base stations will be from about 10 kn to about 20 kn.

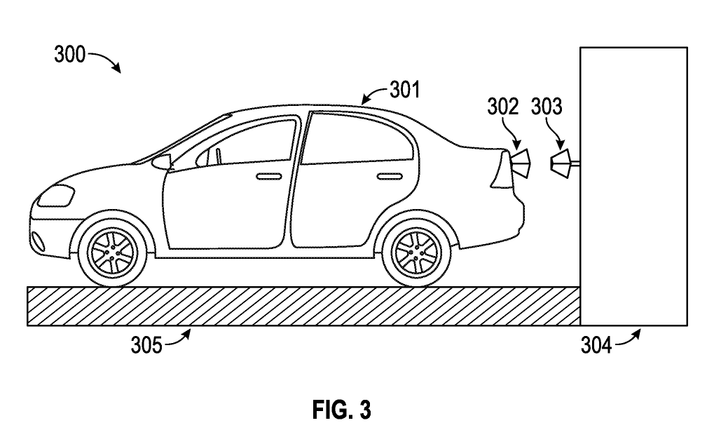

It applications employing these systems, and autonomous aircraft will approach the airborne mobile base station from below and dock using the same procedure already described above except that the z-axis may be inverted. Turning to FIG. 4, a drone (101) is shown just immediately prior to docking with an airborne mobile base station (401). A coupling device (402) is shown extending upwards from the drone and except for his orientation it is otherwise identical to the analogous coupling device shown above and having the reference number (102). A second coupling device is shown extending downward from the airborne mobile base station (403). As prior described, the coupling devices may, in some embodiments, be extendable and retractable. In some embodiments the coupling device extending downward from the airborne mobile base station may be on a swivel such as a ball and socket swivel.

Once the docking is complete, then any function that can be performed from a fixed base station may be performed in the air. In one desirable embodiment, the airborne mobile base station may be employed to refuel and/or recharge the autonomous airborne vehicles. For rotary winged vehicles in general and rotary winged drones in particular, such a refueling or recharging could greatly extend the range of the vehicles thereby minimizing the infrastructure needed in many commercial applications. For example, a single drone could be launched and refueled twice in order to deliver a package rather than having to have two ground-based base stations between the launch site and the delivery point or a single drone could return to the base station multiple times to facilitate delivery of multiple packages. Stated another way, the base station can come to the drone rather than having to have a great number of base stations.

While not as critical for ground based vehicles, the same concept may be employed on the ground. A mobile base station, though ground-based, would reduce the need for fixed place ground stations. In one embodiment, vehicles would be refueled, recharged, and transfer cargo while moving, in yet another, the autonomous vehicle and a mobile base station may rendezvous at a public parking lot where the refueling, recharging, and/or transfer would occur and both of these would be within the scope of the application.

Turning back to the airborne mobile base station, in one embodiment the airborne mobile base station would be a otherwise normal fixed wing aircraft utilizing a runway for takeoff Desirably, it would have a wing surface large enough to allow for not just very slow stall speeds, but also short takeoffs and very efficient flights.

In another embodiment, the airborne mobile base station may be a fixed wing aircraft that is vertical takeoff capable. In either embodiment, center of gravity management will be critical. Especially in vertical takeoff situations center of gravity management is critical. In one particularly desirable embodiment of the systems of the application, either a fixed weight or part of a payload can be configured to be movable along the nose to tail axis of a fixed wing aircraft as part of its control systems.

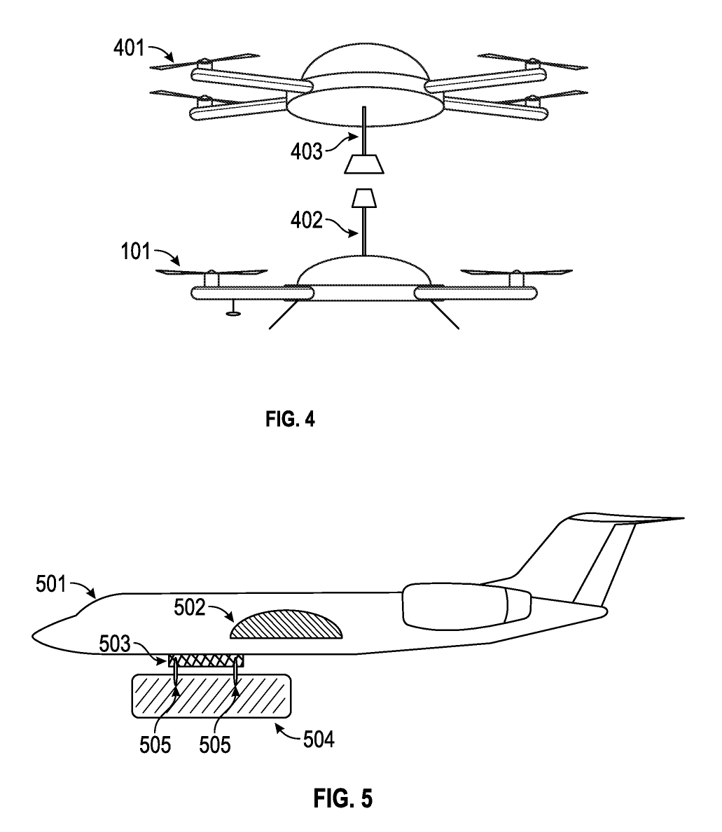

Turning to FIG. 5, part of the fuselage of a fixed wing aircraft (501) is shown. Also shown is a side view of a wing (502) which also represents the approximate center of gravity of the fixed wing aircraft. Running along the keel of the fixed wing aircraft is a movable rail (503). A weight (504) which may be simply ballast or could be cargo or even fuel is attached to the movable rail via the 2 security clamps (505).

In the embodiment illustrated by FIG. 5, the apparatus for shifting the center of gravity is external to the fuselage. In a different embodiment, the apparatus for shifting the center of gravity may be partially or totally internal within the fuselage. A motor (not shown) is employed to move the rail forward and aft during takeoff and/or flight. Such a system could be operated manually, but in at least some embodiments would be operated by the control systems of the aircraft.

In applications where the apparatus for shifting the center of gravity is employed with a vertical takeoff fixed wing aircraft, it would be desirable that the center of gravity be shifted towards the tail of the aircraft during takeoff and then moved forward during the transition from vertical to forward flight.

This aspect of the method and system of the application is also applicable to lighter than air aircraft and any other vehicle or transport where center of gravity stability is necessary or desirable.

While not explicitly illustrated, the operations of the various embodiments of the systems of the application wherein docking took place along the z-axis could be equally performed in the x-axis. This will especially be true in the future where autonomous aircraft are employed that have no external propellers or rotors.

In some embodiments of the systems of the application, the propulsion systems of the autonomous vehicles may be the sole means of keeping the autonomous vehicles in positions relative to the base station. When the base station has its own means of propulsion, it may or may not be employed, as conditions dictate, in order to maintain docking positions during transfers. In contrast, in some embodiments the docking devices may be configured to mechanically maintain docking positions. In still other embodiments, other devices such as clamps may be employed to maintain docking positions. For example, in one such embodiment, a mobile base station could adjust its velocity to facilitate the landing of an aircraft.

In those applications where there is a mechanical method employed to stabilize a docking position, it may be possible to have a mobile base station transport an autonomous vehicle. For example, in one such embodiment, an airborne mobile base station of the systems of the application could be employed to take a drone which is malfunctioning to a central location for maintenance and repair.

The systems of the application may employ additional infrastructure to perform more specialized tasks. In addition to the specialized base stations already disclosed above, the base stations may incorporate other equipment including but not limited to: covers to act as hangers in the event of bad weather or simply to protect autonomous aircraft from the environment; drone movement apparatus to remove a drone from the docking arm and secure it in a storage location such as a shelf attached to the base station; navigational equipment used for emitting a signal used in navigating a drone; security systems useful for preventing or at least mitigating theft or vandalism; and the like.

Another embodiment of the application is a method for employing airborne remotely operated and autonomous vehicles including guiding the vehicles into a position defined by x, y and z coordinates relative to a base station. The base station is configured to perform at least one function selected from the group consisting of refueling, recharging, change of instruments or payload, loading cargo, and unloading cargo; and the at least one function is performed without local human intervention. Also, at least one part of the base station is configured to move in at least one dimension to facilitate the landing of the airborne remotely operated and autonomous vehicles.

In this embodiment, at least one part of the base station is configured to move in at least one dimension, but it may also be configured to move in two or even more dimensions including rotation. Being fixed to the ground, either directly or indirectly, the base station is more stable than an airborne vehicle.

There are several advantages to this method of the application. By making adjustments using both the vehicle itself and the base station, it becomes much more likely that an airborne vehicle can be landed safely. Further, with greater precision available, the actual point of landing on the base station can be reinforced to reduce wear and tear. Lastly, by more precisely landing an airborne vehicle, there'll be less likelihood that the vehicle will have to be relocated after landing prior to refueling, recharging, and the like.

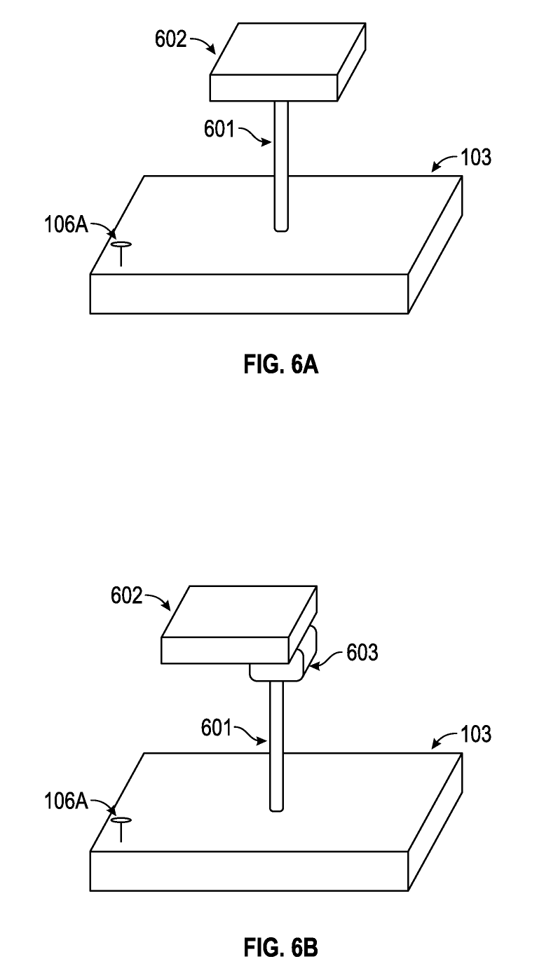

Turning now to FIG. 6A, a base station (103) having a communication device (106 A) is shown. In this embodiment, a section of the base station configured to receive a landing airborne vehicle (602) is shown having been displaced in the z-axis above the base station. In this embodiment the raise section is supported by a simple column (601).

FIG. 6B is substantially similar to FIG. 6A except that a new component has been added. This component (603) is a motor system that is used to displace the section of the base station configured to receive a landing airborne vehicle in at least a second dimension, in this case a displacement along the x axis.

The motor system can be any known to be useful to those of ordinary skill in the art for moving a platform and at least one dimension. For example, in one embodiment the motor system could be a motorized gear and track system.

In both FIG. 6A and FIG. 6B, as an airborne vehicle approaches the base station, the sensors employed by the method of the application are used to direct the airborne vehicle to a position to facilitate landing. As necessary, the section of the base station configured to receive a landing airborne vehicle is in further displaced to position the section to receive the airborne vehicle with as much precision as is necessary.

When conditions deteriorate, it would then be more likely necessary to make displacements of the section of the base station configured to receive a landing airborne vehicle. For example, deteriorated conditions would include but not be limited to periods of high wind, limited visibility, precipitation, and the like.

Another system of the application is a system for delivery of materials utilizing an airborne remotely operated or autonomous vehicle including a cargo hub, a base station, a cargo and supply conveyance system and at least one airborne remotely operated or autonomous vehicle. In this embodiment, the base station is deployed outside of the cargo hub to receive the remotely operated or autonomous airborne vehicle, the cargo and the supply conveyance system is configured to load and unload cargo to and from the remotely operated or autonomous vehicle.

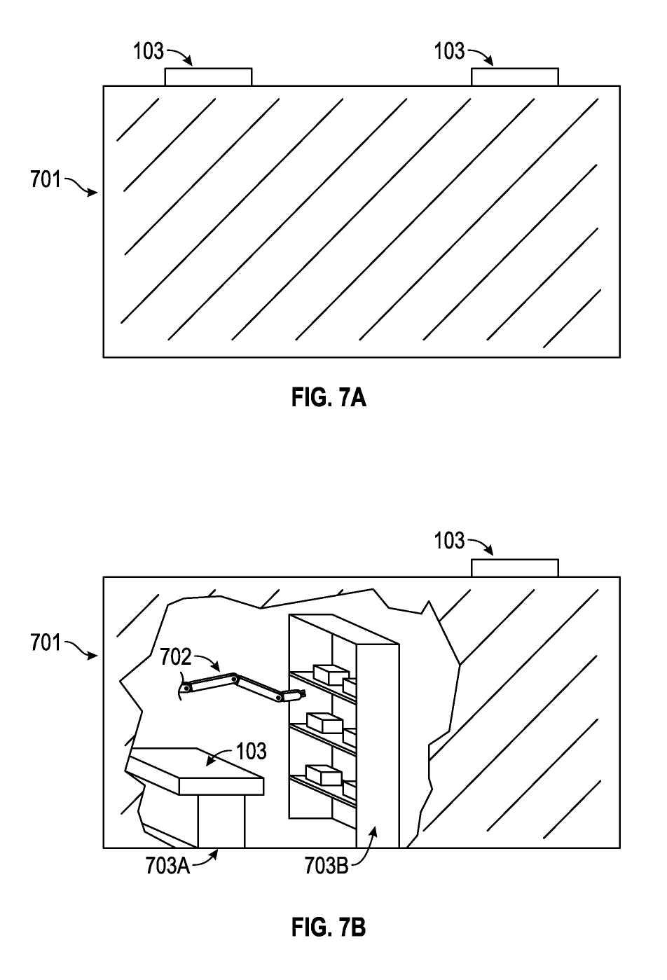

This system of the application allows for the delivery of cargo utilizing airborne remotely operated or autonomous vehicles. Turning now to FIG. 7A, a cargo hub (701) is shown. Deployed on its roof are 2 base stations as already described hereinabove. In his embodiment two remotely operated or autonomous vehicles can be serviced at the same time. The cargo hubs can be fixed or mobile. For example, in one embodiment, the cargo hub would be a centrally located structure configured to receive cargo for delivery by the airborne vehicles and supplies for use in maintaining the airborne vehicles. In another embodiment, the cargo hub could be a vehicle such as a bus or truck that can be moved to a location and employ comparatively short range airborne vehicles for delivery. After all deliveries are made in a given location, then the hub could then be moved to a new location.

The cargo and supply conveyance system is any known to be useful to those of ordinary skill in the art in loading and unloading materials onto aerial vehicles. These can be very simple such as a human assigned to manually perform these conveyances. In the alternative however the cargo and supply conveyance system may be very complex. In such an embodiment, robotic elements such as arms and grapples may be employed to offload spent batteries, load cargo, and even connect charging connectors.

It should be noted that while the cargo hub of the illustrations have the base stations deployed upon their roofs, the base stations could be deployed along the sides of the cargo hub. In some embodiments, the cargo hubs could have openings that would allow the base stations to be deployed within the cargo hub.

Turning now to FIG. 7B, a cutaway illustration is shown wherein one of the base stations has been lowered into the body of the cargo hub employing one element of a conveyance system (703A). Another element of the conveyance system is shown, namely a 3 point articulated robotic arm and hand apparatus (703B) which is employed to convey cargo and supplies from the storage unit (702) to the base unit.

Returning briefly to FIG. 7B, for terrestrial autonomous vehicles, rather than accessing the base station from the top, in some embodiments the base station would be built into the side of the cargo hub. This would facilitate the docking of same with same.

In some embodiments, the base unit would have a separate conveyance system for loading cargo onto the airborne vehicles and also for servicing the airborne vehicles. In an alternative embodiment, the base stations can be lowered into the cargo hub with the airborne vehicles in place and the cargo hub conveyance systems employed to load and service the airborne vehicles. In still another embodiment, neither the base station nor the airborne vehicles are lowered into the cargo hub but instead the cargo and supplies are conveyed from the cargo hub to the base station or directly to the airborne vehicles.

In another embodiment, the cargo hub may include a system for interacting with customers. In such an embodiment, a customer would approach a cargo hub and utilizing a device such as a cell phone or a keypad identify themselves and then receive items delivered by the aerial vehicle. In a related embodiment, the item could be delivered by on autonomous ground based vehicle. In yet another embodiment, the item could be delivered by conventional means.

In some embodiments of the methods and systems of the application, the base station and the autonomous vehicle will each have at least one of a sensor, an energy source to which the sensor is sensitive, and possibly also a passive reflector or marker. In one such embodiment, there are multiple energy sources (selected from radar; radio; visible, infra-red or ultraviolet light; and the like) in a fixed pattern and the sensors function to facilitate to allow the system to dock the autonomous vehicle with the base station. In these embodiments, the input from the sensors functions to provide both location and attitude data.

The processors and controllers used to control the docking process are, in some embodiments, located entirely within the base stations of the systems of the application. In other embodiments, the processors and controllers may be distributed across the system including the autonomous or remotely operated vehicles and the cargo hubs.

During the process of docking, the greatest degree of precision will generally be required immediately prior to docking. For aircraft, this is the last few centimeters wherein the docking mechanism “catches” the aircraft. The reason for this is, in the real world, vehicles travelling through fluids (air and water) are insufficiently stable to make a pinpoint landing. It is therefore desirable to ensure that the primary system for docking is capable of displaying sufficient precisions or employing a second system for the last few centimeters prior to capture. Separate sensors may be employed for this aspect of the method and systems of the application. Such a system may be referred to as a displacement system and it may further function to secure the vehicle to the base station. For example, a barbed or ball shaped displacement measuring mechanism may be employed in addition to the docking probe to lock on to the vehicle for these last few critical centimeters. One such system would be one where there is a second articulation near the end of the docking probe. In another embodiment, the displacement mechanism could be on the vehicle itself.

Any other equipment necessary to facilitate the docking of vehicles with the systems of the application may be employed. For example, in some of the embodiments, the base station and/or the cargo hub may be mobile. The use of manned vehicles for imparting mobility is within the scope of this application subject to the limitation that a vehicle is employed that is either remotely operated or autonomous.

Another of example of such of other equipment can be one where the scale and or configuration of the vehicle to be docked is not compatible with the base station. In situations such as this, the vehicle or the base station may be equipped with devices to compatibilize the vehicle with base stations such as using rods to extend the footprint of a small vehicle and the like.

The docking probe may move in all three dimensions, x; y; and z. In some embodiments, as a vehicle approaches the base station, the docking probe will, in a seek mode, attempt to align in two dimensions, and then when a minimum degree of stability is achieved, move in the third dimension to affect catching the vehicle. Generally, the probe will align in the x and y axes, and then extend in the z axis. In some embodiments, where the base station is mobile, the base station itself can be moved to supplement the motion of the probe. In still other embodiments, a portion of the base station can also move to supplement the motion of the probe.

In the method useful with present application, in some embodiments, a vehicle docks and lands in order to unload cargo. In other embodiments, a full landing is not necessary. For example, in one embodiment of the application, a vehicle, upon reaching the position defined by x, y, and z coordinates relative to a base station, releases its cargo allowing gravity or some force or system to complete delivery.

What is claimed is:

1. A method for employing remotely operated and autonomous vehicles comprising guiding the vehicles into a position defined by x, y and z coordinates relative to a base station, wherein:
the base station is configured to perform at least one function selected from the group consisting of providing shelter, a home base, refueling, loading cargo, and unloading cargo; and
the at least one function is performed without local human intervention.

2. The method of claim 1 wherein the base station employs a docking probe for coupling with the remotely operated and autonomous vehicles, and the docking probe can move in at least one dimension to facilitate the coupling.

3. The method of claim 2 wherein the base station employs a sensor to facilitate the coupling with the remotely operated and autonomous vehicles.

4. The method of claim 2 wherein at least a part of the base station moves in at least one dimension to facilitate the coupling of the docking probe and the remotely operated and autonomous vehicles.

5. The method of claim 2 wherein the base station is configured to load and unload cargo employing a cargo conveyance system.

6. A system for employing remotely operated and autonomous vehicles comprising:
a base station,
an apparatus used to guide the vehicles into a position defined by x, y and z coordinates relative to a base station,
wherein:
the base station is configured to perform at least one function selected from the group consisting of refueling, loading cargo, and unloading cargo; and
the base station is configured to perform the at least one function without local human intervention.

7. The system of claim 6 wherein the base station includes a docking probe configured to facilitate coupling with the remotely operated and autonomous vehicles.

8. The system of claim 7 wherein the docking probe includes a magnet configured to facilitate coupling with the remotely operated and autonomous vehicles.

9. The system of claim 7 wherein the base station includes a sensor configured to facilitate coupling with the remotely operated and autonomous vehicles.

10. The system of claim 7 wherein the remotely operated and autonomous vehicles include a sensor configured to facilitate coupling with the remotely operated and autonomous vehicles.

11. The system of claim 7 wherein the remotely operated and autonomous vehicles and the base station include a sensor configured to facilitate coupling with the remotely operated and autonomous vehicles.

12. The system of claim 7 wherein the docking probe can move in at least one dimension to facilitate the coupling with the remotely operated and autonomous vehicles.

13. The system of claim 7 wherein at least a part of the base station can move in at least one dimension to facilitate the coupling with the remotely operated and autonomous vehicles.

14. The system of claim 7 wherein the base station includes cargo conveyance systems to facilitate the loading and unloading of cargo to and from the remotely operated and autonomous vehicles.

15. The system of 14 wherein the cargo conveyance system comprises robotic elements.

16. The system of claim 14 wherein the cargo conveyance system is configured to work with a cargo conveyance system within a cargo hub.

17. A method for docking remotely operated and autonomous vehicles on a base station comprising:
guiding the vehicles into a position defined by x, y and z coordinates relative to a base station; and
employing a docking probe to couple the base station and the remotely operated and autonomous vehicles wherein,
at least one sensor is employed to control movement of the remotely operated and autonomous vehicles as close to the base station as is practical for making a docking, and
at least one of the base station or a part thereof and the docking probe are moved in at least one dimension to facilitate the coupling of the docking probe which is in turn employed to achieve a precision docking.

18. The method of claim 17 wherein the remotely operated and autonomous vehicles are selected from the group consisting of a fixed wing aircraft, a rotor aircraft, a lighter than air aircraft, or a land or water vehicle.

19. The method of claim 18 wherein the remotely operated and autonomous vehicles are selected from the group consisting of a fixed wing aircraft, a rotor aircraft, and a lighter than air aircraft.

20. The method of claim 19 further comprising landing the remotely operated and autonomous vehicles after docking.
